(19) United States
(12) Patent Application Publication
(10) Pub. No.: US 2012/0169825 A1
(43) Pub. Date: Jul. 5, 2012

(54) IP Multimedia Subsystem (IMS)-Based Pre-negotiation of Video Codec For Video Single Radio Video Call Continuity

(75) Inventor: Milan Patel, Harrow (GB)

(73) Assignee: INTERDIGITAL PATENT HOLDINGS, INC., Wilmington, DE (US)

(21) Appl. No.: 13/177,298

(22) Filed: Jul. 6, 2011

Related U.S. Application Data
(60) Provisional application No. 61/361,740, filed on Jul. 6, 2010.

(51) Int. Cl. H04N 7/14

(52) U.S. Cl. 348/14.01; 348/E07.077

(57) ABSTRACT

Systems, methods, and instrumentalities are disclosed to provide pre-negotiation of a video codec. An IP multimedia subsystem (IMS) entity, such as a service centralization and continuity application server (SCC AS), may send a first session initiation protocol (SIP) message to a circuit switched domain entity via an IMS core network. The first SIP message may correspond to a video call in an on-going IP multimedia subsystem (IMS) session. The first SIP message may include one or more video codecs supported by the SCC AS and the UE associated with the video call. The SCC AS may receive a second SIP message from the circuit switched domain entity. The second SIP message may include the video codec, which may be one of the video codecs included in the first SIP message. The SCC AS may send the video codec to a user equipment (UE) associated with the video call.

### CROSS-REFERENCE TO RELATED APPLICATIONS

This application claims the benefit of U.S. Provisional Patent Application No. 61/361,740, filed on Jul. 6, 2010, the contents of which are hereby incorporated by reference herein.

### BACKGROUND

IP multimedia subsystem (IMS) defines a sophisticated 3G service delivery infrastructure that may be access independent, i.e., the service provider may deliver consistent blended services across multiple user equipment (UE) types which may access the network using different technologies. Voice call continuity (VCC) may be a part of the IMS user experience. VCC functionality may include support for automatic network selection by the UE, and how to perform an in-call handoff (HO) between access technologies.

Single access mode devices may provide specific UE capabilities through a single type of network. Each access technology may have unique air interface characteristics and a dedicated network infrastructure to register and validate users and provide services including telephony and messaging.

3GPP TR 23.886, the content of which is incorporated herein in its entirety, relates to single radio video call continuity (vSRVCC). Current systems and methods for vSRVCC may overburden packet switched (PS) entities.

### SUMMARY

Systems, methods, and instrumentalities are disclosed to provide pre-negotiation of a video codec. An IP multimedia subsystem (IMS) entity, such as a service centralization and continuity application server (SCC AS), may send a first session initiation protocol (SIP) message to a circuit switched domain entity via an IMS core network. The first SIP message may correspond to a video call in an on-going IMS session. The first SIP message may include one or more video codecs supported by the SCC AS and a UE associated with the video call. The SCC AS may receive a second SIP message from the circuit switched domain entity. The second SIP message may include the video codec. The video codec received in the second SIP message may be one of the one or more video codecs included in the first SIP message. The SCC AS may send the video codec to a user equipment (UE) associated with the video call.

Entities that may initiate pre-negotiation may include the UE and the SCC AS. For example, if the SCC AS initiates pre-negotiation, it may do so by sending the first SIP message. The UE may initiate pre-negotiation by sending an SIP message to the SCC AS. In such a case, the first SIP message may be in response to the initiation by the UE.

The video codec may be capable of being used by the UE associated with the video call to substantially maintain integrity of a video part and a voice part when transferring the video call from a packet switched domain to a circuit switched domain. The video codec may be pre-negotiated without packet switched signaling in an EUTRAN.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an another example radio access network and an another example core network that may be used within the communications system illustrated in FIG. 1A;

FIG. 1E is a system diagram of an another example radio access network and an another example core network that may be used within the communications system illustrated in FIG. 1A;

FIG. 1F illustrates an exemplary block diagram of an vSRVCC architecture and associated procedures.

FIG. 2 illustrates an exemplary message flow diagram of vSRVCC without DTM handover (HO) support.

FIG. 3 illustrates an exemplary message flow diagram of vSRVCC with DTM HO support.

FIG. 4 illustrates an exemplary message flow diagram of basic IMS procedures to support vSRVCC-PS-CS transfer.

FIG. 5 illustrates an exemplary message flow diagram showing pre-negotiation of video codec;

FIG. 6 illustrates an exemplary message flow diagram showing pre-negotiation in the IMS prior to HO to the PS domain as initiated by the SCC AS;

FIG. 7 illustrates an exemplary message flow diagram showing procedures for IMS-based pre-negotiation of video codec as initiated by the UE;

FIG. 8 illustrates an exemplary message flow diagram of an exemplary approach for transferring a video call with vSRVCC; and

FIG. 9 illustrates an exemplary flow chart of an exemplary video codec negotiation.

### DETAILED DESCRIPTION OF ILLUSTRATIVE EMBODIMENTS

A detailed description of illustrative embodiments may now be described with reference to the Figures. However, while the present invention may be described in connection with exemplary embodiments, it is not limited thereto and it is to be understood that other embodiments may be used or modifications and additions may be made to the described embodiments for performing the same function of the present invention without deviating therefrom. In addition, the figures may illustrate call flows, which are meant to be exemplary. It is to be understood that other embodiments may be used. The order of the flows may be varied where appropriate. Also, flows may be omitted if not needed and additional flows may be added.

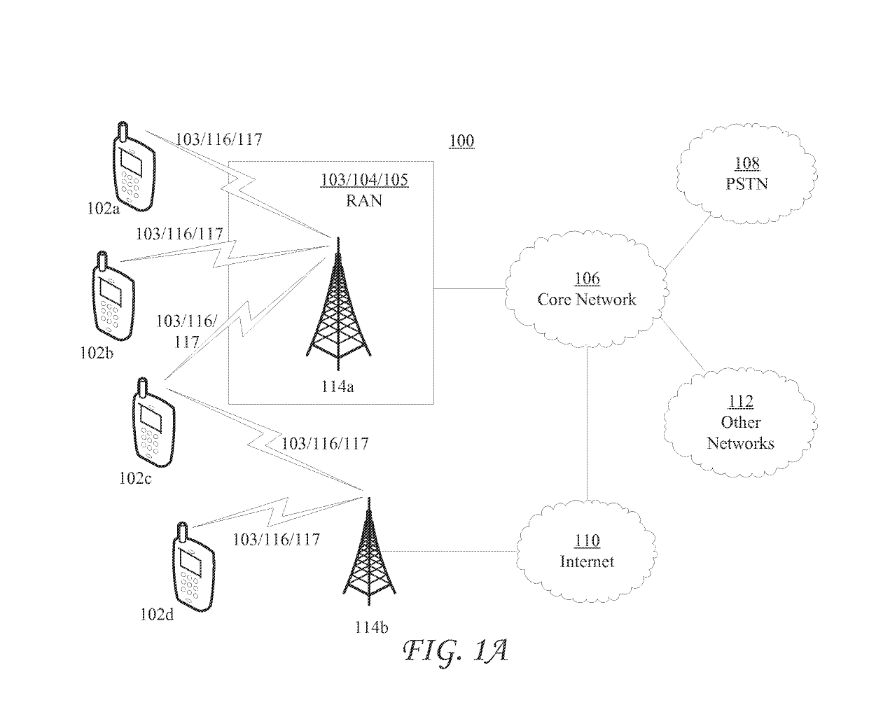

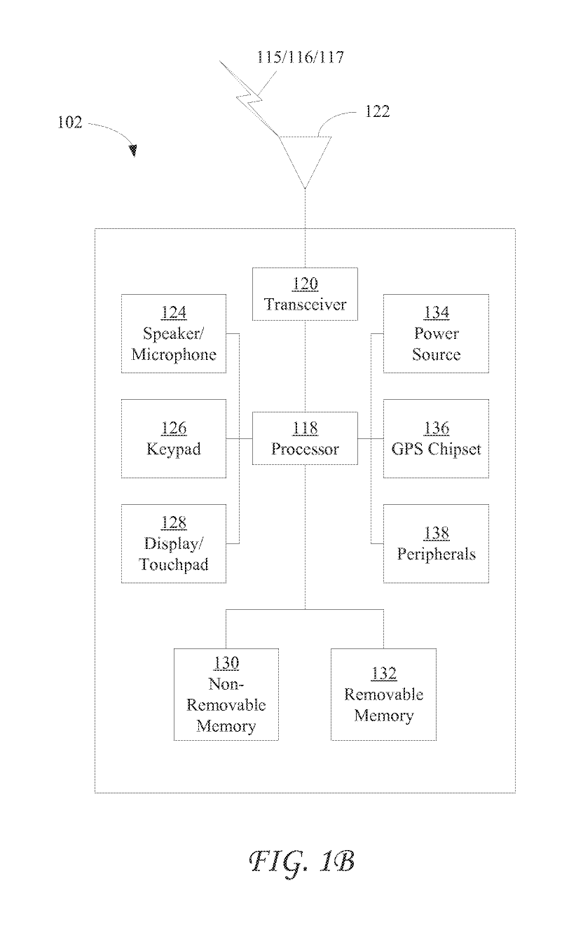

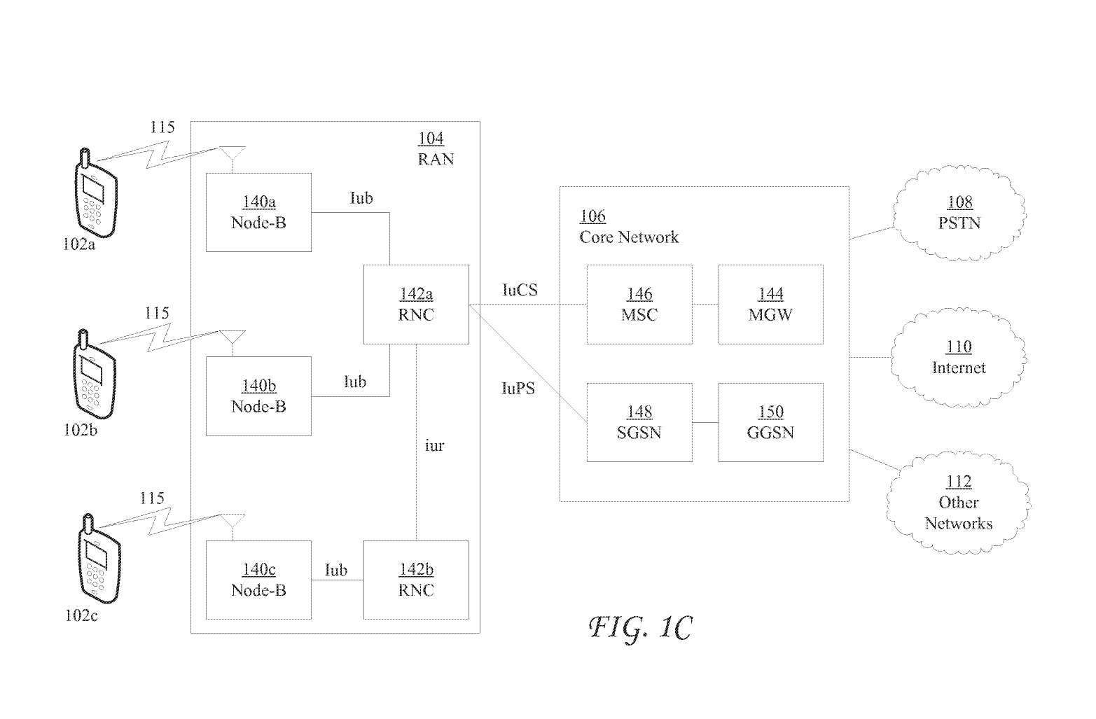

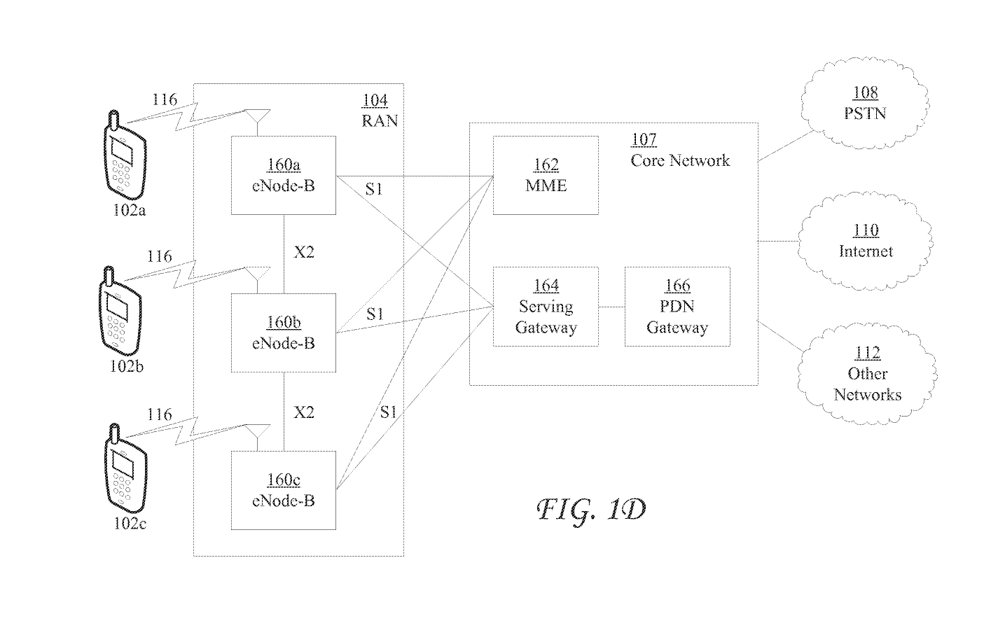

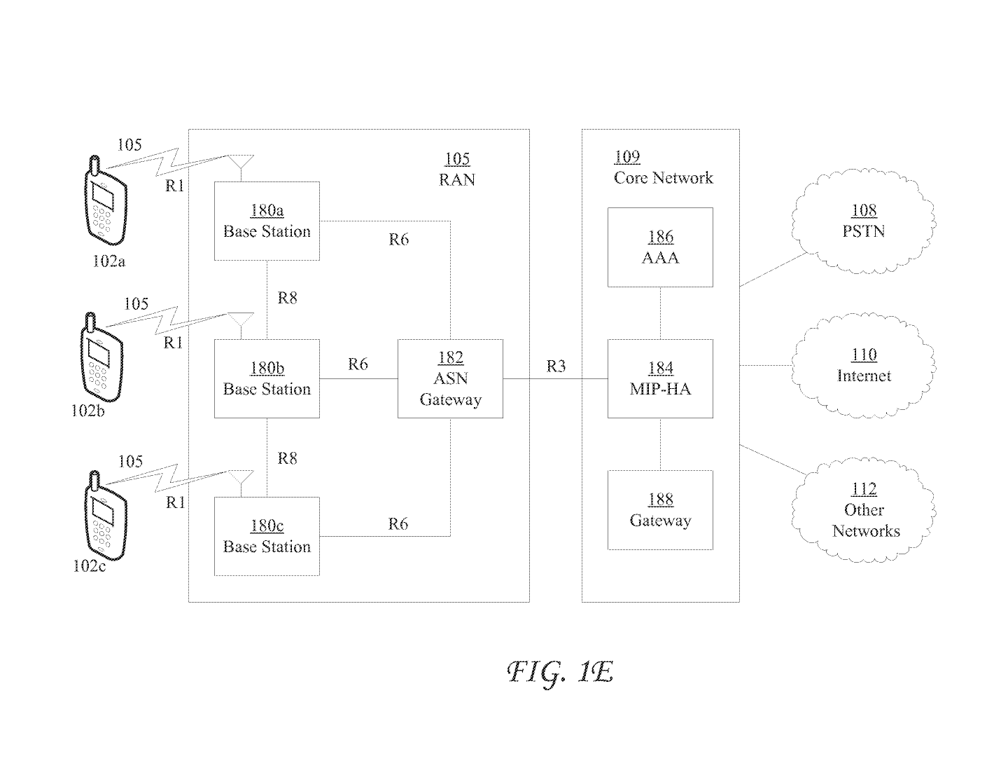

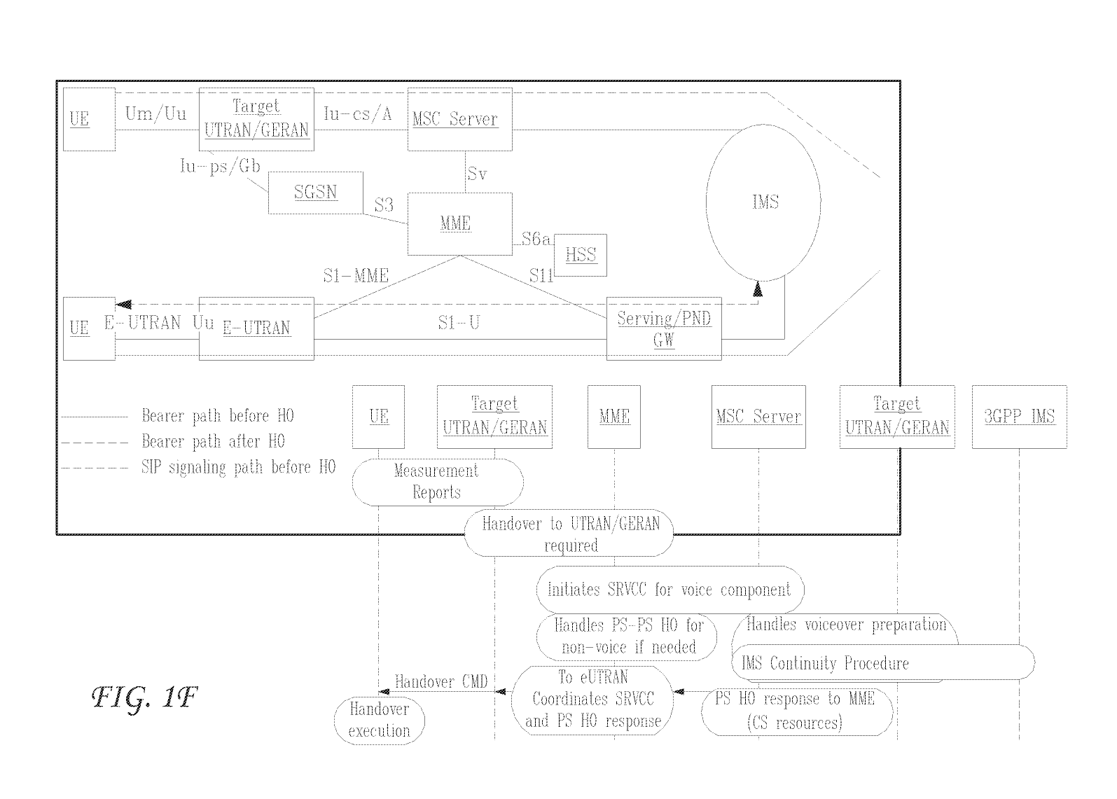

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the Si interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

FIG. 1F illustrates an exemplary block diagram of an vSRVCC architecture and associated procedures.

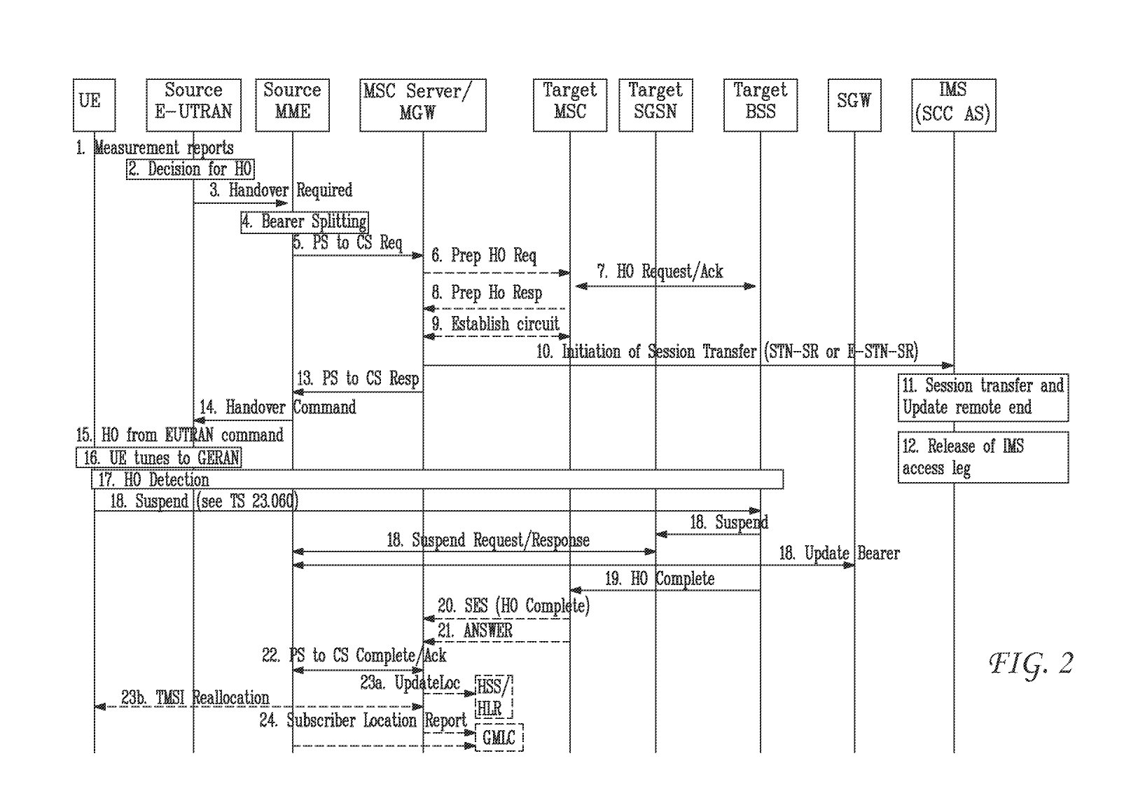

FIG. 2 illustrates an exemplary message flow diagram of vSRVCC without DTM handover (HO) support.

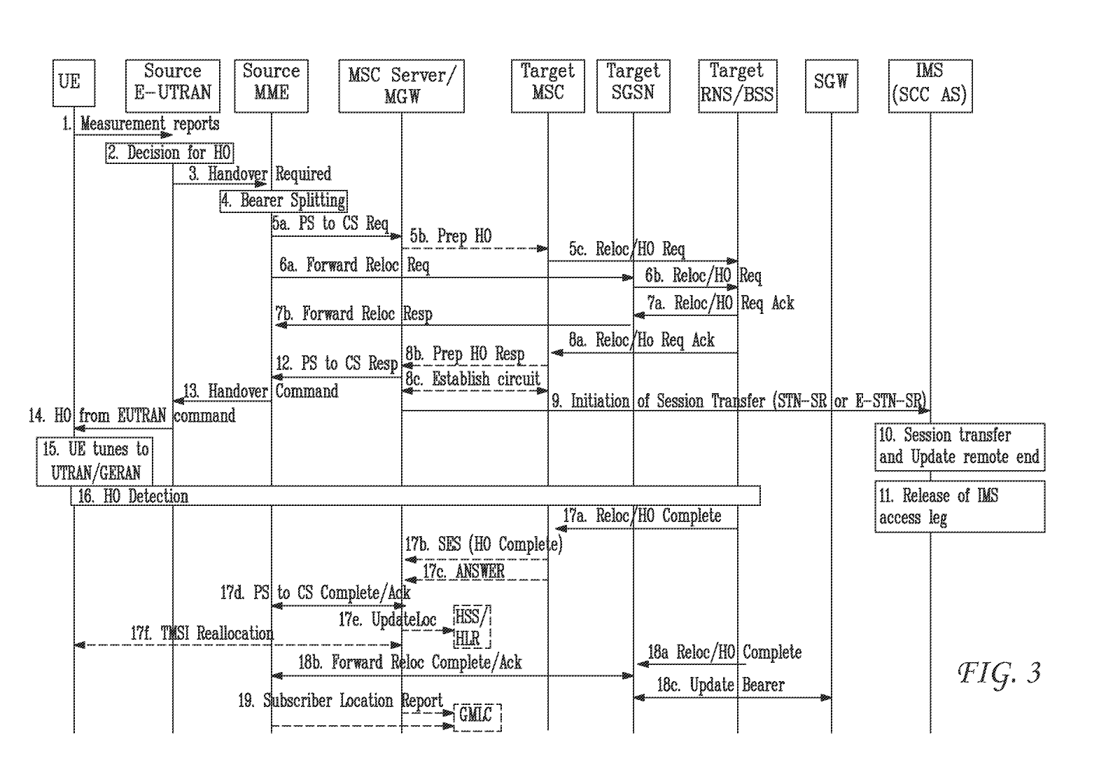

FIG. 3 illustrates an exemplary message flow diagram of vSRVCC with DTM HO support.

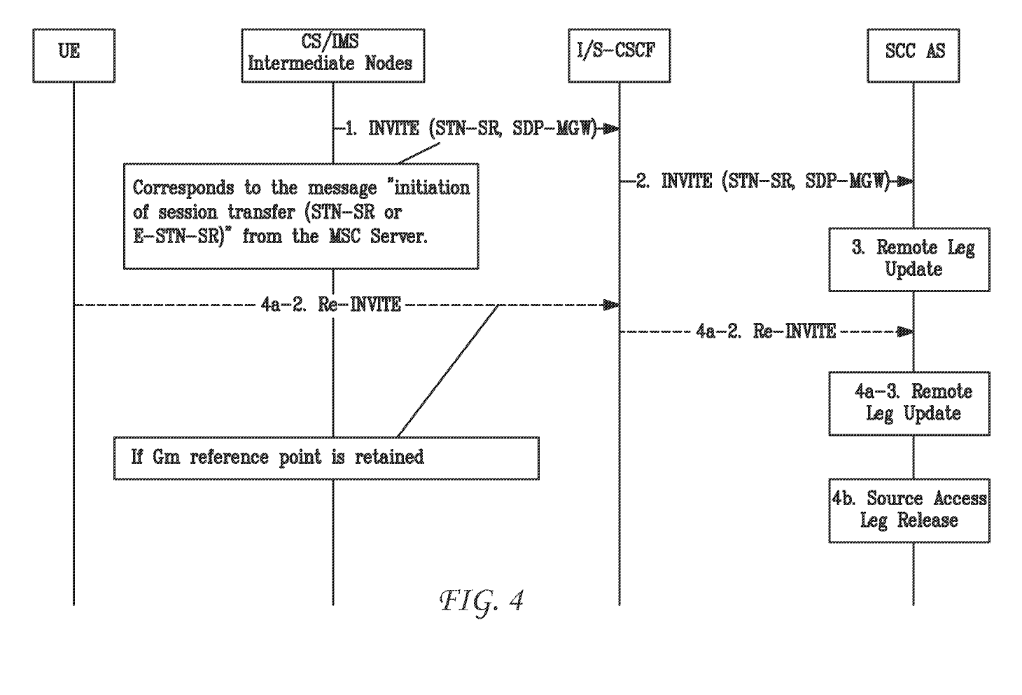

FIG. 4 illustrates an exemplary message flow diagram of basic IMS procedures to support vSRVCC-PS-CS transfer.

Systems, methods, and instrumentalities are disclosed to provide pre-negotiation of a video codec. An IP multimedia subsystem (IMS) entity, such as a service centralization and continuity application server (SCC AS), may send a first session initiation protocol (SIP) message to a circuit switched domain entity via an IMS core network. The first SIP message may correspond to a video call in an on-going IMS session. The first SIP message may include one or more video codecs supported by the SCC AS and a UE associated with the video call. The SCC AS may receive a second SIP message from the circuit switched domain entity. The second SIP message may include the video codec. The video codec received in the second SIP message may be one of the one or more video codecs included in the first SIP message. The SCC AS may send the video codec to a user equipment (UE) associated with the video call.

Entities that may initiate pre-negotiation may include the UE and the SCC AS. For example, if the SCC AS initiates pre-negotiation, it may do so by sending the first SIP message. The UE may initiate pre-negotiation by sending an SIP message to the SCC AS. In such a case, the first SIP message may be in response to the initiation by the UE (e.g., the first SIP message may be a request for codec negotiation that is sent in response to receiving the SIP message from the UE initiating negotiation).

The video codec may be capable of being used by the UE associated with the video call to substantially maintain integrity of a video part and a voice part when transferring the video call from a packet switched domain to a circuit switched domain. The video codec may be pre-negotiated without packet switched signaling in an EUTRAN.

Pre-negotiation may be referred to as a method of reducing the transfer time of a video call from the IMS to CS domain (e.g., by negotiating a video codec before handover). It is anticipated that transfer of a video call may be longer than transfer of a voice call due to the additional video codec negotiation. Transfer of a video call from a packet switched domain to a circuit switched domain may cause a degradation of the audio part and/or the video part of the video call. That is, integrity of the audio part and/or the video part of the video call may not be maintained when the call is transferred from a packet switched domain to a circuit switched domain. The disclosed systems, methods, and instrumentalities may provide for IMS-based pre-negotiation of a video codec for the transfer of a video call from an IMS domain (packet switched domain) to a CS domain when a device (e.g., UE) supports a single radio.

A scenario for transfer of a video call when a single radio is supported by the UE may be where the E-UTRAN is used as the access during an IMS-based video call and the video call is transferred to the CS domain where UTRAN is the access network.

Message flows for illustrating exemplary IMS-based pre-negotiation of one or more video codecs for vSRVCC are disclosed. The exemplary message flows may illustrate messaging that may be used during the codec pre-negotiation procedures. Entities involved in types of pre-negotiation may include one or more of the following: a UE (e.g., a UE that is being used for a video call), a source EUTRAN/MME (PS entity), an MSC server/MGW (CS entity), a target MSC (CS entity), a target packet core/BSS (CS entity), a SGW (PS entity), an IMS core network, and a service centralization and continuity application server (SSC AS, IMS entity).

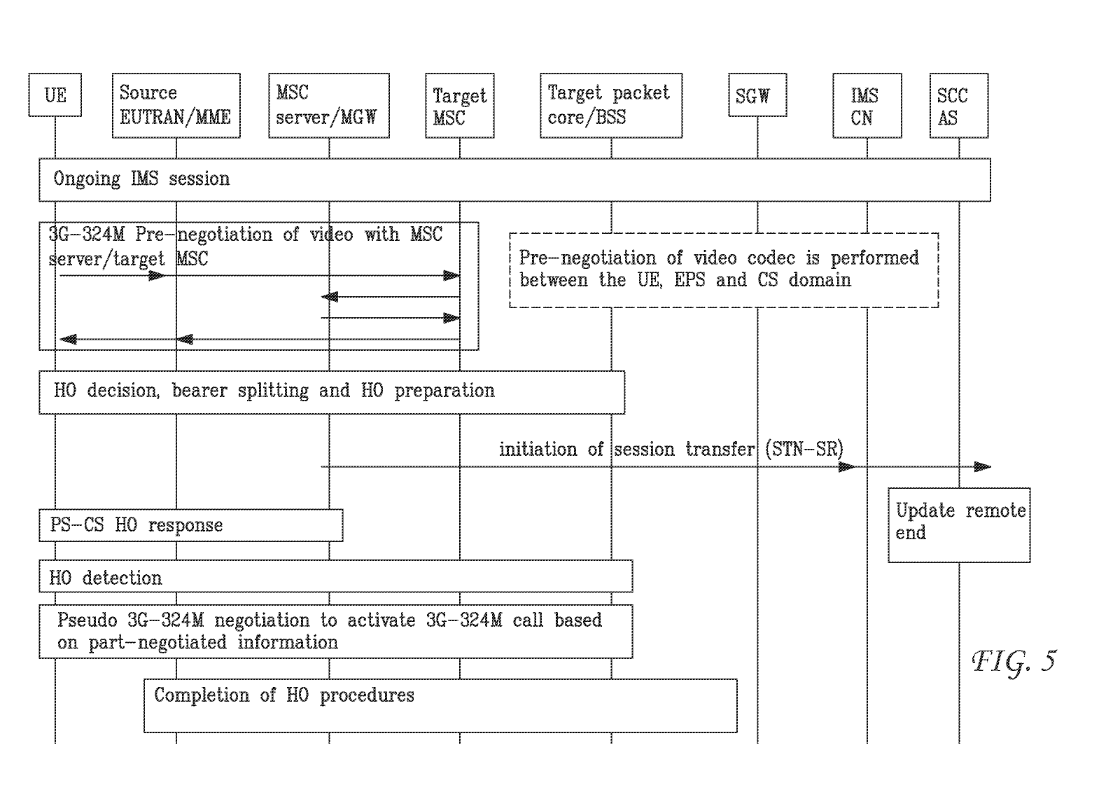

FIG. 5 illustrates a message flow diagram showing pre-negotiation of video codec. In FIG. 5, negotiation may be performed in the packet core network rather than in the IMS.

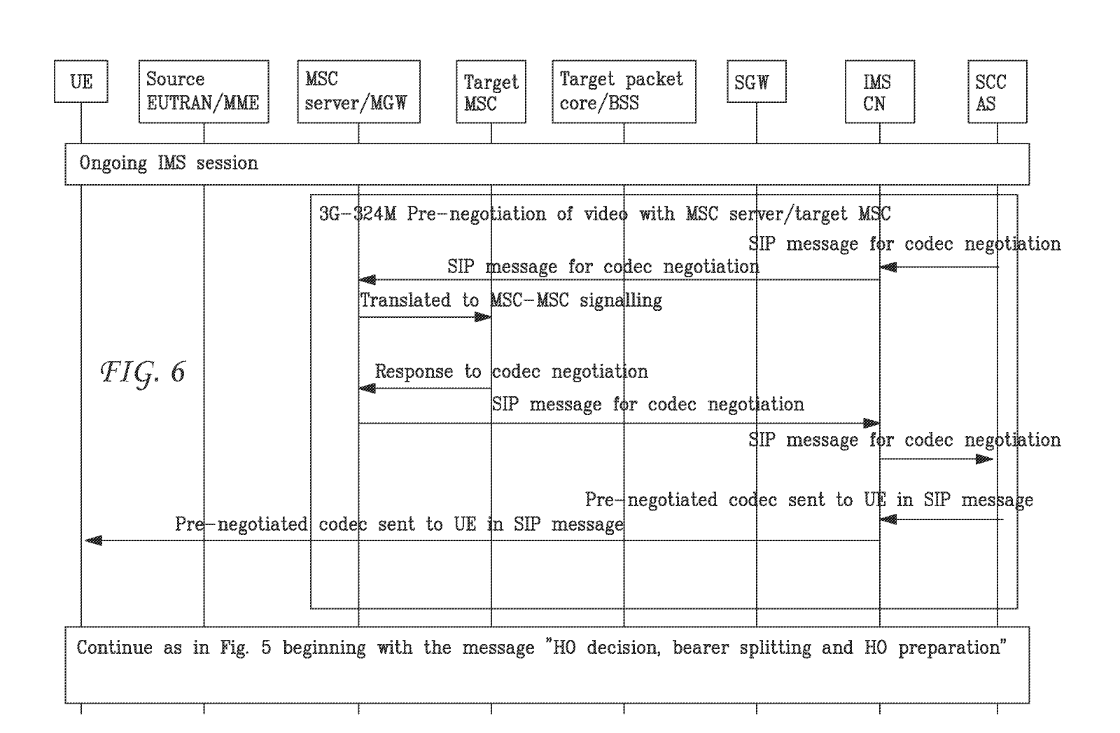

FIG. 6 illustrates a message flow diagram showing pre-negotiation in the IMS prior to HO to the PS domain. Referring to FIG. 6, codec negotiation may be initiated by an SCC AS using IMS/SIP signaling (an SIP message) towards the MSC server via the IMS CN. The SCC AS may be required to know the video codec capabilities of the UE beforehand. This may be conveyed during registration, subscription, registration or dialog event packages, or during session setup of the IMS session. The SIP message towards the MSC server may include one or more video codecs supported by the UE and SCC AS. As part of the negotiation, the MSC server may send an SIP message to the SCC AS via the IMS CN. The SIP message from the MSC server may include a video codec. The video codec in the SIP message from the MSC server may be one of the one or more video codecs included in the first SIP message. The pre-negotiated video codec may then be sent to the UE by the SCC AS (e.g., in an update message).

Video codec negotiation in the IMS may be part of the offer/answer process that occurs during session establishment INVITE or during re-INVITE. Pre-negotiation in the IMS has advantages in that EPS (enhanced packet-core system) signaling need not be invoked for the codec negotiation prior to the HO decision. The video codec negotiation can be part of the offer/answer messaging that occurs during INVITE or re-INVITE. The codec negotiation may occur after session set up using, for example, a re-INVITE message and following the offer/answer messaging procedures.

As disclosed herein, IMS-based video codec pre-negotiation may be initiated by the SCC AS or UE associated with the video call.

In the case of SCC AS initiated pre-negotiation, an exemplary benefit may be that the UE need not be involved in the pre-negotiation until the negotiated codec is to be sent to the UE. The SCC AS may need to know the UE's codec capabilities (e.g., it may be received in the offer SDP during the initiation of the IMS session or registration).

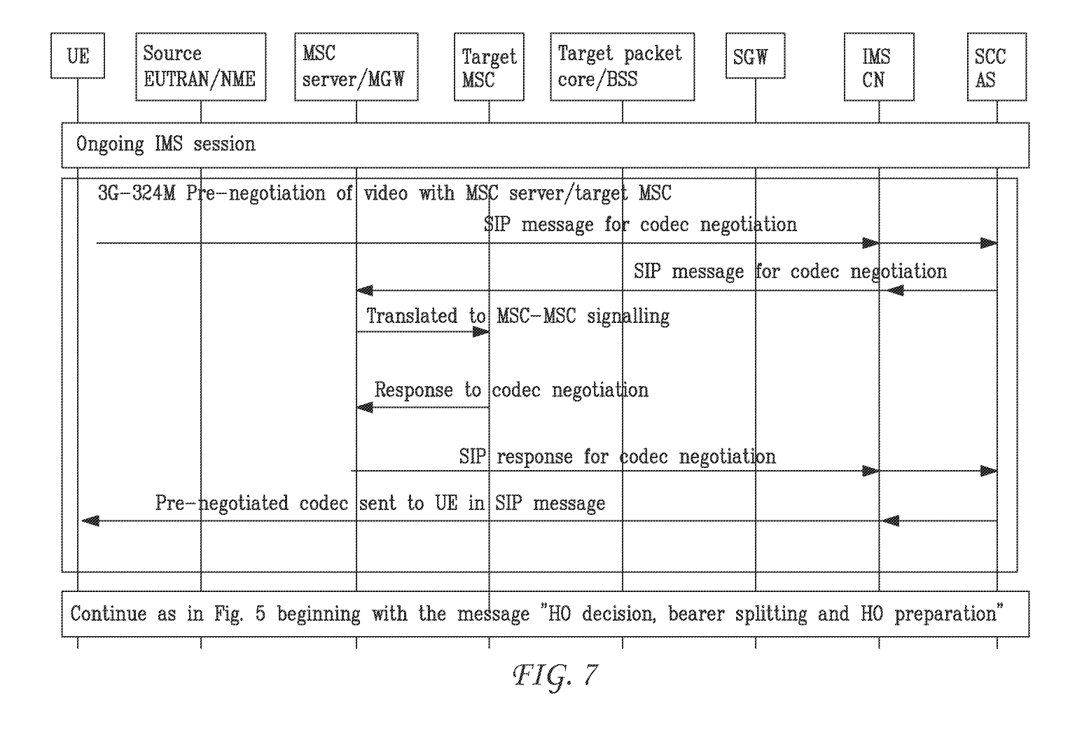

FIG. 7 illustrates a message flow diagram showing procedures for IMS-based pre-negotiation of video codec initiated by the UE. Referring to FIG. 7, the exemplary video codec negotiation may be initiated by the UE using IMS/SIP signaling (an SIP message) towards the SCC AS via the IMS CN. The SCC AS may send the request towards the MSC server via the IMS CN (e.g., similar to FIG. 6). The SIP message towards the MSC server may include one or more video codecs supported by the UE and SCC AS. As part of the negotiation, the MSC server may send an SIP message to the SCC AS via the IMS CN. The SIP message from the MSC server may include a video codec. The video codec in the SIP message from the MSC server may be one of the one or more video codecs included in the first SIP message. The pre-negotiated video codec may then be sent to the UE by the SCC AS (e.g., in an update message).

The SIP message for the codec negotiation may be an OPTIONS request in order to provide capability exchange. The SIP message for the codec negotiation may be an INVITE request. The SIP request may be a different, but appropriate SIP method (i.e., not limited to INVITE and OPTIONS).

The SIP request may include an SDP body with an Offer that includes video codecs supported by the UE and by intermediate SIP entities. The request may be translated to MSC-MSC signaling that includes the supported codecs.

The MGW and MSC server may provide a response with the supported codec in the UTRAN/GERAN CS system, which may be subsequently translated to an SIP response (e.g., 200 OK), that includes the SDP body with an Answer. The UE may store this negotiated codec information to be used in subsequent “pseudo” pre-negotiation procedures.

VCC Release 7 and Service Continuity (SC) Release 8 may provide requirements and procedures for transfer of a session from PS domain (IMS) to the CS domain. VCC and SC may rely on the UE having dual radio support (e.g., WLAN to UTRAN CS HO). In the case of VCC and SC, codec negotiation for the voice and video components are performed in IMS. However, the INVITE request that includes the SDP offer may be initiated from the target access leg (e.g., CS SETUP message for transferring session to CS domain may be interworked to SIP INVITE at MSC server/MGCF).

Systems, methods, and instrumentalities are disclosed herein that may provide pre-negotiation of the video codec in the IMS prior to HO to the CS domain. The disclosed IMS-based pre-negotiation may not include MME-MSC communication being necessary until HO is required. The SIP-based negotiation may need to be between the UE or SCC AS and the SIP-enabled MSC server. Such communication may allow the MSC server to obtain correlation information from the IMS to correlate the on-going IMS session with the HO request that is received by the MSC via the MME. After pre-negotiation is completed, the vSRVCC procedures for IMS and EPS methods may be similar.

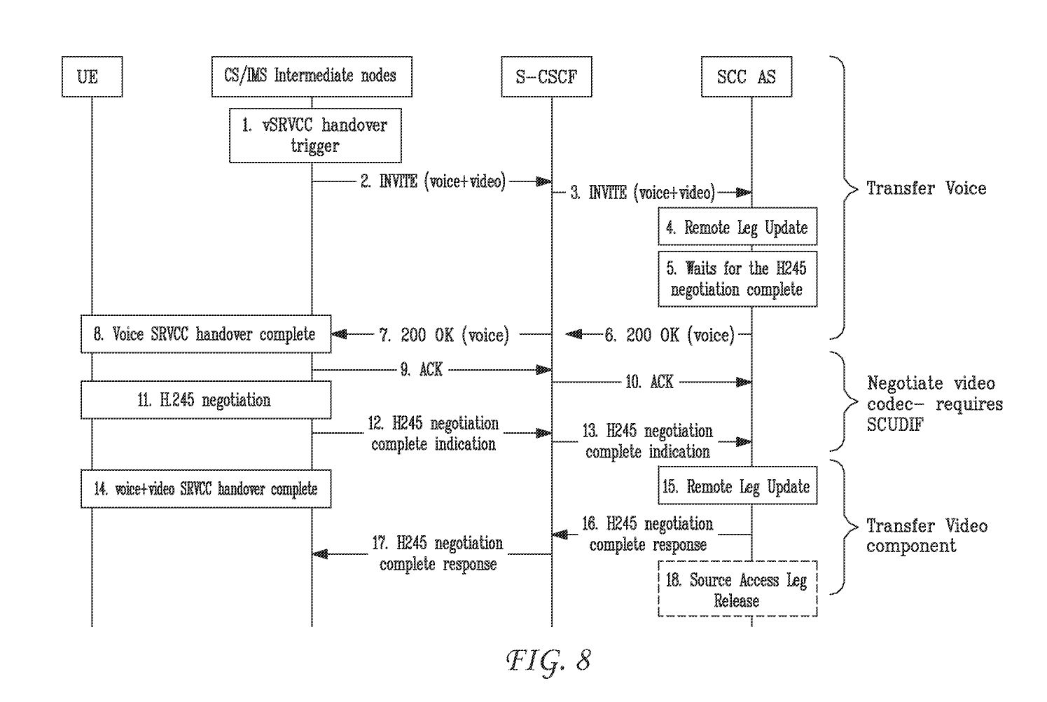

A two-step approach may be used for transferring a video-call with vSRVCC. For MTSI and 3G-324M, three video codecs (e.g., H.263, MPEG-4, and H.264) may be standardized. In the case of 3G-324M, only H.263 and MPEG-4 are typically implemented. MTSI may begin with H.264 at higher bit rates and larger image sizes than those of 3G-324M. FIG. 8 illustrates a message flow diagram of an exemplary approach for transferring a video call with vSRVCC.

3G-324M pre-negotiation for vSRVCC domain transfer may assume that the UE and the network have the capability of combined TA and LA update, which eventually may enable an LTE located UE to know corresponding T-MSC. It may prepare future needs of 3G-324M in the CS domain, with T-MSC via MSC-S/MGW while the process to locate UE in the PS domain during PS session may be on-going. Pre-negotiation may be wasteful since the vSRVCC of the video may not occur if HO is not required (e.g., the UE stays in one location and does not lose PS coverage).

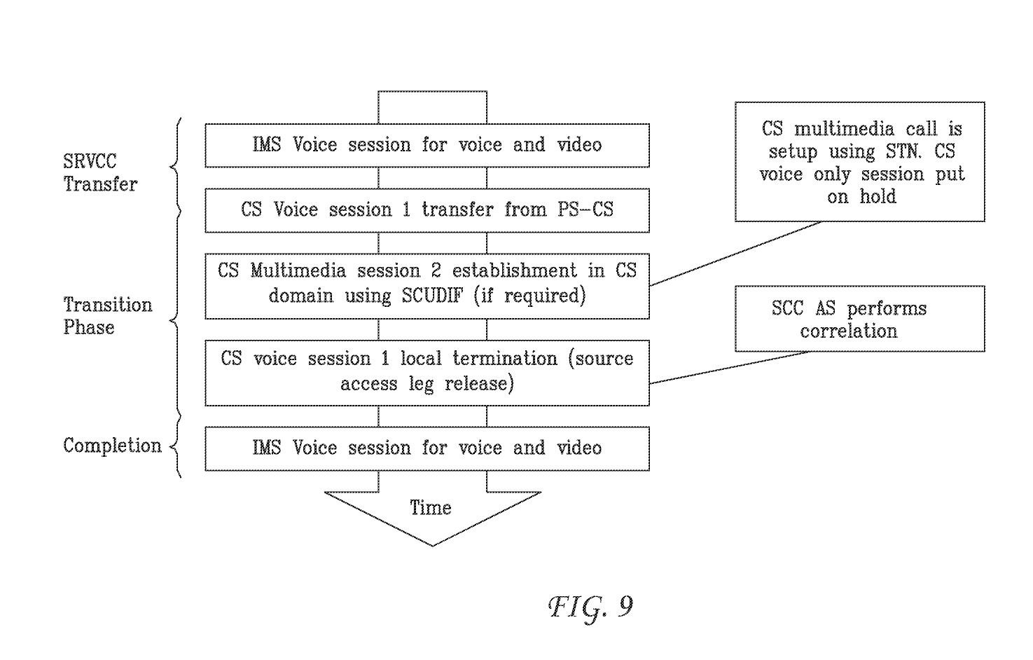

FIG. 9 illustrates a call flow chart of exemplary video codec negotiation. Referring to FIG. 9, a two step procedure with UE initiated multimedia call establishment (without need of SCUDIF) may be provided. In this example, there may be no impacts to legacy CS procedures and no dependency on SCUDIF.

Transferring a video call with vSRVCC may require the negotiation of video codecs during the HO procedure. An eNodeB may prepare the transparent container indicating that video bearer (QCI=2) as well as voice bearer (QCI=1)n of video codecs during the HO procedure. MME may perform bearer splitting. MME may send an indication to the MSC server in PS to CS request to offer video SDP as well as voice. Transferring voice and video together may delay voice transfer beyond the 300 ms performance requirement.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method to pre-negotiate a video codec, the method comprising:
sending a first session initiation protocol (SIP) message to a circuit switched domain entity via an IP multimedia subsystem (IMS) core network, wherein the first SIP message corresponds to a video call in an on-going IP multimedia subsystem (IMS) session;
receiving a second SIP message from the circuit switched domain entity, wherein the second SIP message includes the video codec; and
sending the video codec to a user equipment (UE) associated with the video call.

2. The method of claim 1, wherein the first SIP message initiates pre-negotiation of the video codec.

3. The method of claim 1, wherein the first SIP message is in response to a third SIP message received from the UE, and wherein the third SIP message initiates pre-negotiation of the video codec.

4. The method of claim 1, wherein the first SIP message includes one or more video codecs supported by the UE and an IMS entity.

5. The method of claim 4, wherein the video codec received in the second SIP message is one of the one or more video codecs included in the first SIP message.

6. The method of claim 1, wherein the video codec is capable of being used by the UE to substantially maintain integrity of a video part and a voice part when transferring the video call from a packet switched domain to a circuit switched domain.

7. The method of claim 1, wherein the video codec is pre-negotiated without packet switched signaling in a EUTRAN.

8. A service centralization and continuity application server (SCC AS) configured to:
send a first session initiation protocol (SIP) message to a circuit switched domain entity via an IP multimedia subsystem (IMS) core network, wherein the first SIP message corresponds to a video call in an on-going IP multimedia subsystem (IMS) session;
receive a second SIP message from the circuit switched domain entity, wherein the second SIP message includes the video codec; and
send the video codec to a user equipment (UE) associated with the video call.

9. The SCC AS of claim 8, wherein the first SIP message initiates pre-negotiation of the video codec.

10. The SCC AS of claim 8, wherein the first SIP message is in response to a third SIP message received from the UE, and wherein the third SIP message initiates pre-negotiation of the video codec.

11. The SCC AS of claim 8, wherein the first SIP message includes one or more video codecs supported by the UE and an IMS entity.

12. The SCC AS of claim 11, wherein the video codec received in the second SIP message is one of the one or more video codecs included in the first SIP message.

13. The SCC AS of claim 8, wherein the video codec is capable of being used by the UE to substantially maintain integrity of a video part and a voice part when transferring the video call from a packet switched domain to a circuit switched domain.

14. The SCC AS of claim 9, wherein the video codec is pre-negotiated without packet switched signaling in a EUTRAN.
